(19) United States
(12) Patent Application Publication
(10) Pub. No.: US 2022/0058224 A1
(43) Pub. Date: Feb. 24, 2022

(54) Computer application to view digital content and submit rating with user's data, which can be queried and filtered as a sample polling system.

(71) Applicant: Erin Oliver Jones, Rowlett, TX (US)

(72) Inventor: Erin Oliver Jones, Rowlett, TX (US)

(21) Appl. No.: 17/329,236

(22) Filed: May 25, 2021

Related U.S. Application Data
(60) Provisional application No. 63/069,093, filed on Aug. 23, 2020.

(51) Int. Cl. G06F 16/9035; G06F 16/9038; G06F 16/903

(52) U.S. Cl. CPC G06F 16/9035; G06F 16/90335; G06F 16/9038

(57) ABSTRACT

The present invention is a digital application that streamlines and provides access to public opinion of newsworthy information (FIG. 2-B) in a more granular process. It creates records by combining a user-submitted rating of digital content (FIG. 2-C) with data from a user created profile (FIG. 1-A), not limited to categories including age, race, gender, or location. A rating could include a positive rating, negative rating, a non-factual rating, or numbered score (FIG. 3-E). User's data and rating is aggregated and displayed as statistical metrics (FIG. 3-C) related to the individual digital content being viewed (FIG. 3-D) or grouped by keywords. The aggregated user data and ratings can be queried and filtered by each category (FIG. 4-H) to provide a sample poll relating to the content or topic (FIG. 5-J). Statistical outliers are identified to help determine if/where a bias exists.

### TECHNICAL FIELD

The present invention generally relates to improvements of crowdsourcing user ratings of content and more particularly in regards to feedback on news articles tied to a user's identifying personal data. This application claims the benefit of provisional patent application No.: 63069093.

### BACKGROUND ART

Opinions of news information are generally viewed from a comments section. However, there is no background information in regards to age, gender, location, race, education, political views, or religion for whoever is leaving a comment. Comments are not easily aggregated for an entire population or have the ability to filter users based on said background information. A statistical, majority opinion cannot be tied to a distinct characteristic of users, be it age, gender, location, etc.

### SUMMARY OF THE INVENTION

The present invention is designed to allow a user to upload their personal data such as age, gender, location, etc. and have said information recorded with a rating of a news content. The user will login and view newsworthy content through a feed. The user will be able to rate content, such as having the opinion that it is fake news, or not factual, and submit the rating along with their personal data. Users can see the aggregated ratings of the entire population of users who have previously submitted. Users can query a sample of user's ratings based on filtered results of other user's personal data. For example, unqueried results for an article could state a 100% non-factual rating. Utilizing a query and selecting the sample of ratings of users who only live in Texas could show a result of a 60% non-factual rating. Furthermore, utilizing another query and selecting the sample of ratings of users who only live in Texas and are also male could show a result of a 30% non-factual rating. The purpose, is to highlight human bias in regards to differentiating categorization. Ratings given by female Users could differ drastically from their male counterparts about a given piece of information. This type of curation can display statistical outliers of public opinion that can be filtered by different human characteristics of users to help quantify such differences.

### DESCRIPTION OF DRAWINGS

FIG. 1-A) A user will create profile data that will be tied to all ratings submitted by the user. The profile can contain information, but not limited to, age, race, gender, etc.

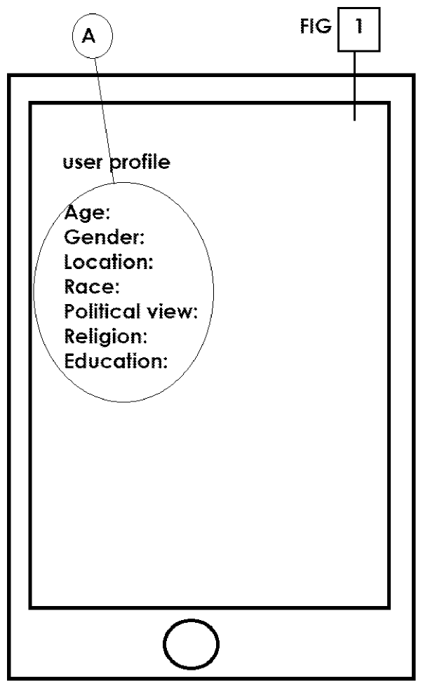

FIG. 2-B) The content could be a feed of news articles that displays C) the aggregated, unfiltered ratings of the population of users for each article.

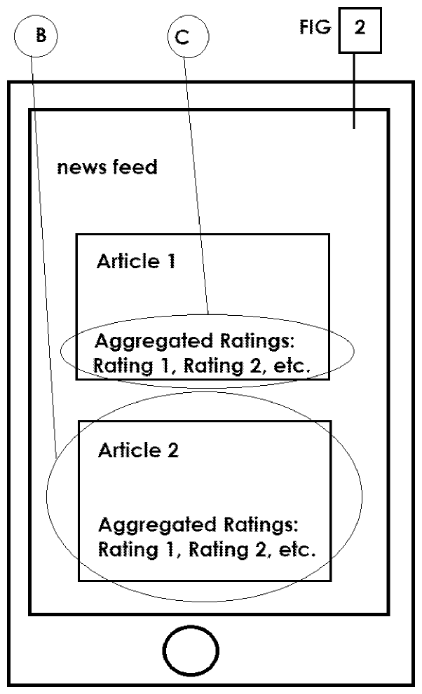

FIG. 3-D) The user views the content in detail, which could comprise the body of information from a news article. C) The said aggregated ratings are viewable again to provide context. E) Once consumed, the user can select a rating of the content, which will be F) submitted and recorded along with their said profile data. G) Users can use a query tool.

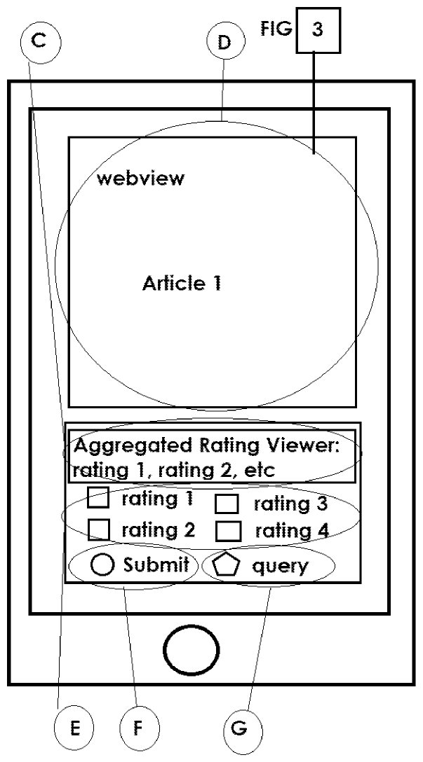

FIG. 4-H) The query tool creates sample data of ratings by filtering other user's profile data from the population of ratings previously submitted for the content or keywords. The user could filter out ratings from users by specific locations, religions, races, etc. I) The user will submit the query and have results returned.

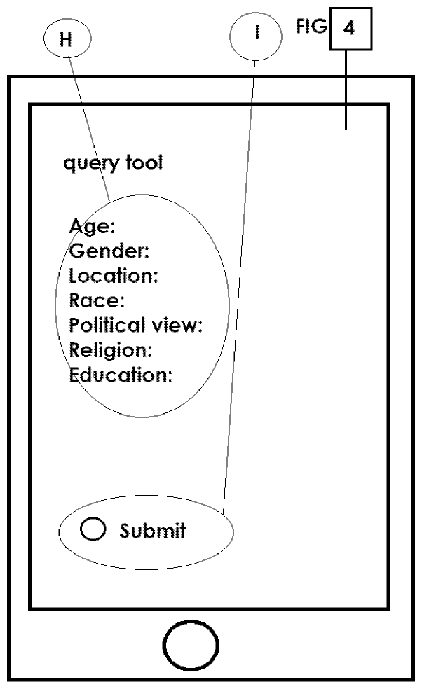

FIG. 5-J) The ratings of the queried sample data is aggregated and displayed in place of the unfiltered ratings of the entire population who have rated the content through the application, providing a more granular perspective of any perceived human bias.

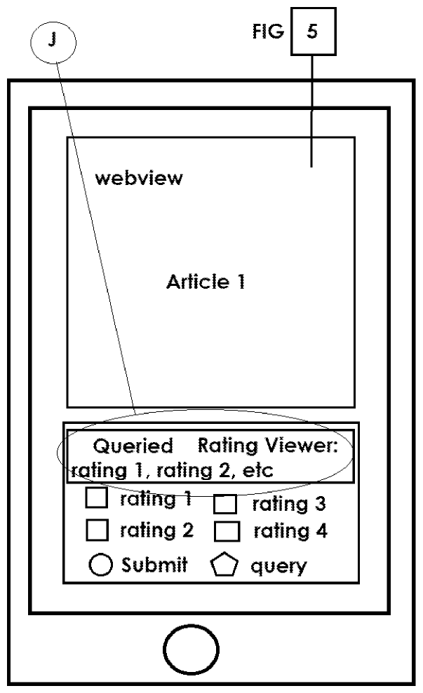

1. A computer application comprising:
a data array containing personal information from the user along with a rating of content;
a polling system to submit said rating of content tied to said data array; and
a query system to filter and generate sample data of said ratings by matching of said data array.
